(19) United States
(12) Patent Application Publication
(10) Pub. No.: US 2022/0098915 A1
(43) Pub. Date: Mar. 31, 2022

(54) MOVING BODY

(71) Applicant: HONDA MOTOR CO., LTD., Tokyo (JP)

(72) Inventors: Tadahiro MATORI, Tokyo (JP); Shingo NAKAYAMA, Tokyo (JP); Shohei IWAMOTO, Tokyo (JP); Tohko NAKAI, Tokyo (JP)

(73) Assignee: HONDA MOTOR CO., LTD., Tokyo (JP)

(21) Appl. No.: 17/486,070

(22) Filed: Sep. 27, 2021

(30) Foreign Application Priority Data
Sep. 30, 2020 (JP) 2020-166248

(51) Int. Cl. E05F 15/43; E05F 15/73

(52) U.S. Cl. CPC E05F 15/43; E05F 15/73; E05F 2015/483; E05Y 2900/532; E05F 2015/434

(57) ABSTRACT

A moving body includes: an opening and closing body, attached to be openable and closable, including: an opening operation device operated by a user when opening the opening and closing body; an external world information acquisition device including an external world information acquisition unit which acquires external world information of the moving body; a panel member forming an outer shell of the moving body; and a garnish member attached to an outer surface of the panel member, which is a surface on an outer side of the moving body. The external world information acquisition device is fixed to the panel member, and the opening operation device is fixed to the garnish member.

### CROSS-REFERENCE TO RELATED APPLICATIONS

The present application claims the benefit of priority of Japanese Patent Application No. 2020-166248, filed on Sep. 30, 2020, the content of which is incorporated herein by reference.

### TECHNICAL FIELD

The present invention relates to a moving body such as a vehicle, and more particularly to a moving body capable of autonomous movement.

### BACKGROUND ART

In related arts, a moving body equipped with an external world information acquisition device has been known. For example, JP-A-2012-066763 discloses a vehicle including a back door which is openably and closably attached and a back camera which is an external world information acquisition device attached to the back door.

The vehicle described in JP-A-2012-066763 is provided with a door opening switch, which is an opening operation device, and the back camera, which is the external world information acquisition device, on a lower surface of a garnish provided on the back door and a user opens the back door by pressing the door opening switch, grasping the garnish, and pivoting the back door upward.

However, in the vehicle described in JP-A-2012-066763, the door opening switch which is the opening operation device and the back camera which is the external world information acquisition device are both provided in the garnish. Therefore, when the user operates the door opening switch, which is the opening operation device, a load input by an operation of the door opening switch by the user is transmitted to the back camera, which is the external world information acquisition device. As a result, there is a risk that a mounting position or a mounting angle of the back camera would change.

In a moving body which can move autonomously such as an autonomous driving vehicle, which has been actively researched and developed in recent years, when the mounting position or mounting angle of the external world information acquisition device changes, accuracy of external world information acquired by the external world information acquisition device may decrease, and thus appropriate autonomous movement may not be possible.

### SUMMARY

The invention provides a moving body which can prevent a load input to an opening operation device by an operation of the opening operation device of an opening and closing body by a user from being transmitted to an external world information acquisition device attached to the opening and closing body and changing a mounting position or a mounting angle of the external world information acquisition device.

According to an aspect of the invention, there is provided a moving body including

an opening and closing body, attached to be openable and closable, including:

an opening operation device operated by a user when opening the opening and closing body; and

an external world information acquisition device including an external world information acquisition unit which acquires external world information of the moving body;

a panel member forming an outer shell of the moving body; and

a garnish member attached to an outer surface of the panel member, which is a surface on an outer side of the moving body, where:

the external world information acquisition device is fixed to the panel member; and

the opening operation device is fixed to the garnish member.

According to the invention, the external world information acquisition device is fixed to the panel member, while the opening operation device is fixed to the garnish member. Thus, the load input to the opening operation device by the operation of the opening operation device by the user is prevented from being transmitted to the external world information acquisition device. As a result, it is possible to prevent the load input to the opening operation device by the operation of the opening operation device of the opening and closing body by the user from being transmitted to the external world information acquisition device attached to the opening and closing body and changing the mounting position and mounting angle of the external world information acquisition device.

### BRIEF DESCRIPTION OF THE DRAWINGS

FIG. 1 is a perspective view of a vehicle according to an embodiment of the invention as viewed diagonally from the front left.

FIG. 2 is a perspective view of a vehicle according to the embodiment of the invention as viewed diagonally from the right rear with a tailgate open.

FIG. 3 is a rear view of the vehicle according to the embodiment of the invention as viewed from the rear.

FIG. 4 is an enlarged view of a main part around a handle portion of FIG. 3.

FIG. 5 is a perspective view of a main portion viewed from diagonally rear left with a garnish member 184 removed, around the handle portion of FIG. 4.

FIG. 6 is a LiDAR device provided at a tailgate of the vehicle of FIG. 1.

FIG. 7 is a cross-sectional view taken along the line A-A of FIG. 4.

FIG. 8 is a block diagram illustrating a vehicle control device for the vehicle of FIG. 1.

FIG. 9 is a diagram illustrating a modification example of the LiDAR device of FIG. 6.

### DESCRIPTION OF EMBODIMENTS

Hereinafter, a vehicle as an embodiment of a moving body of the invention will be described with reference to the accompanying drawings. The drawings shall be viewed in a direction of reference letters. In the specification and the like, in order to simplify and clarify the explanation, each direction of front-rear, left-right, and up-down is described according to a direction seen from a driver of the vehicle. In the drawing, the front of the vehicle is shown as Fr, the rear is shown as Rr, the left is shown as L, the right is shown as R, the upper side is shown as U, and the lower side is shown as D.

(Vehicle)

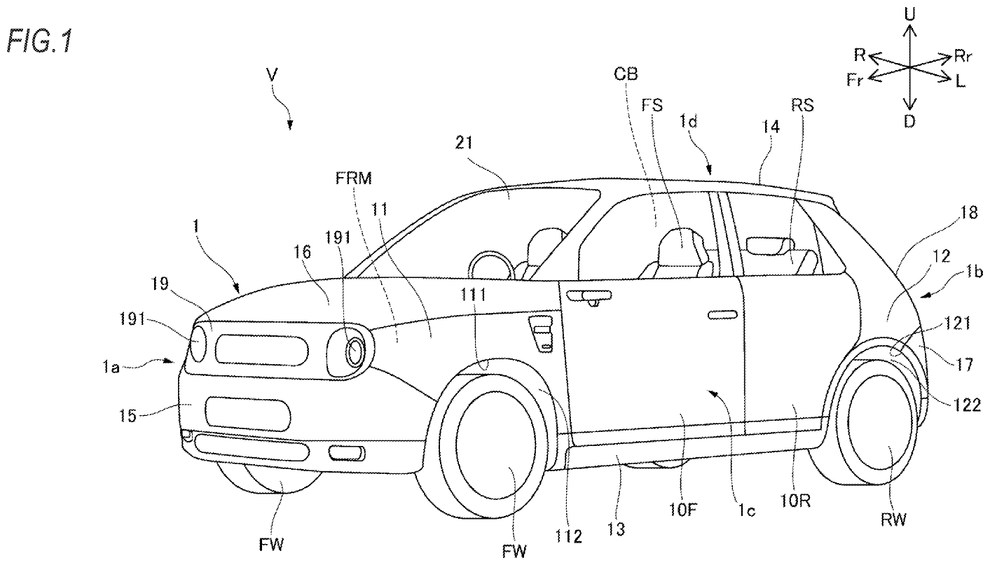

First, a configuration of a vehicle V of the embodiment will be described with reference to FIG. 1.

The vehicle V is a moving body capable of autonomous movement. Hereinafter, the autonomous movement of the vehicle V is also referred to as autonomous driving.

As illustrated in FIG. 1, the vehicle V is an automobile including a drive source (not illustrated) and wheels including a drive wheel driven by power of the drive source and a steerable steering wheel. In the embodiment, the vehicle V is a four-wheeled automobile including a pair of left and right front wheels FW and rear wheels RW. The drive source of the vehicle V is, for example, an electric motor. The drive source of the vehicle V may be an internal combustion engine such as a gasoline engine or a diesel engine, or may be a combination of an electric motor and an internal combustion engine. The drive source of the vehicle V may drive the pair of left and right front wheels FW, the pair of left and right rear wheels RW, or four wheels of the pair of left and right front wheels FW and left and right rear wheels RW. Both the front wheel FW and the rear wheel RW may be steerable wheels, or one thereof may be a steerable wheel.

The vehicle V includes, for example, a skeleton member (not illustrated) having a monocoque structure formed by welding a steel plate panel and an outer shell member 1 which covers the skeleton member and forms an outer shell of the vehicle V. The vehicle V includes a cabin CB for accommodating an occupant and a front room FRM formed in front of the cabin CB. Both the cabin CB and the front room FRM are spaces surrounded by the outer shell member 1. The cabin CB and the front room FRM are separated by a dash panel (not illustrated) extending in an up-down direction and a left-right direction. The drive source of the vehicle V and the like are accommodated in the front room FRM.

The outer shell member 1 has a front surface 1a facing the front of the vehicle V, a rear surface 1b facing the rear of the vehicle V, a pair of left and right side surfaces 1c facing the left and right directions of the vehicle V, and an upper surface id facing upward of the vehicle V.

The outer shell member 1 includes a pair of left and right front doors 10F forming the left and right side surfaces 1c of the vehicle V on a front side of the cabin CB and a pair of left and right rear doors 10R forming the left and right side surface 1c of the vehicle V on a rear side of the cabin CB, The outer shell member 1 includes a pair of left and right front fender panels 11 forming the left and right side surfaces 1c of the vehicle V in front of the front door 10F and a pair of left and right rear fender panels 12 forming the left and right side surfaces 1c of the vehicle V behind the rear door 10R. The outer shell member 1 includes a pair of left and right side sills 13 extending in the front-rear direction from the front fender panels 11 on the left and right sides of the vehicle V to the rear fender panels 12 along lower edges of the front door 10F and the rear door 10R. The outer shell member 1 includes a roof panel 14 extending in the front-rear direction and the left-right direction along the upper edges of the pair of left and right front doors 10F and left and right rear doors 10R to form an upper surface of the cabin CB of the vehicle V. The outer shell member 1 includes a front bumper 15 which forms a lower portion of a front surface of the front room FRM of the vehicle V and a bonnet 16 which forms an upper surface of the front room FRM of the vehicle V. The outer shell member 1 includes a rear bumper 17 which forms a lower portion of a rear surface of the vehicle V and a tailgate 18 which forms an upper portion of the rear surface of the vehicle V.

The front fender panel 11 is formed with a front wheel arch portion 111 which is curved in a substantially arc shape in which a lower edge of the front fender panel 11 is convex upward. A front wheel house 112 is formed below the front wheel arch portion 111 and the front wheel FW is accommodated in the front wheel house 112.

The rear fender panel 12 is formed with a rear wheel arch portion 121 which is curved in a substantially arc shape in which a lower edge of the rear fender panel is convex upward. A rear wheel house 122 is formed below the rear wheel arch portion 121 and the rear wheel RW is accommodated in the rear wheel house 122.

The front bumper 15 has a shape in which left and right ends wrap around to the left and right front wheel arch portions 111.

Above the front bumper 15, a front garnish 19 extending vertically and horizontally from the front fender panel 11 on the left side to the front fender panel 11 on the right side is provided between the front bumper 15 and the bonnet 16. A pair of left and right headlights 191 which illuminate the front of the vehicle V are provided at both left and right end portions of the front garnish 19. The pair of left and right headlights 191 are provided to be separated from each other in the left-right direction.

As such, the front bumper 15 and the front garnish 19 form the front surface 1a of the outer shell member 1. The rear bumper 17 and the tailgate 18 form the rear surface 1b of the outer shell member 1. The pair of left and right front doors 10F, the pair of left and right rear doors 10R, the pair of left and right front fender panel 11, the pair of left and right rear fender panels 12, and the pair of left and right side sill 13 form the pair of left and right side surfaces 1c of the outer shell member 1. The roof panel 14 forms the upper surface id of the outer shell member 1.

A front window 21 is provided on a front surface of the cabin CB. The front window 21 is formed of a light transmitting member, for example, glass, which allows the outside of the vehicle to be visually recognized from inside the cabin CB. The front window 21 extends downward from a front end portion of the roof panel 14 to a vicinity of a rear end portion of the bonnet 16 while inclining forward. The front window 21 extends over substantially the entire area in the left-right direction of the vehicle V.

The cabin CB, which is inside the vehicle V, is provided with a front seat FS in which an occupant can be seated and a rear seat RS which is disposed behind the front seat FS and in which an occupant can be seated.

(Rear Structure of Vehicle)

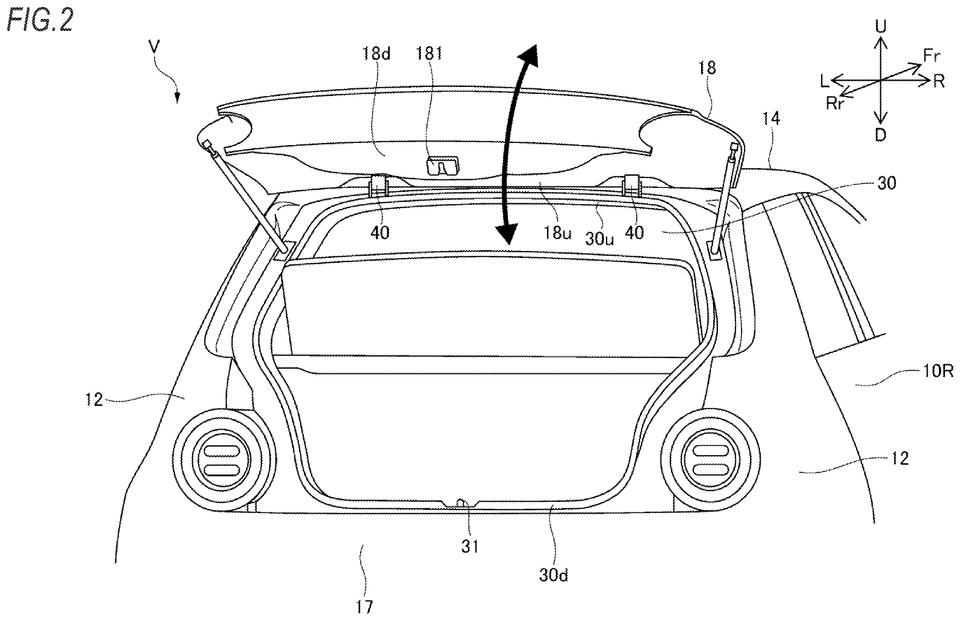

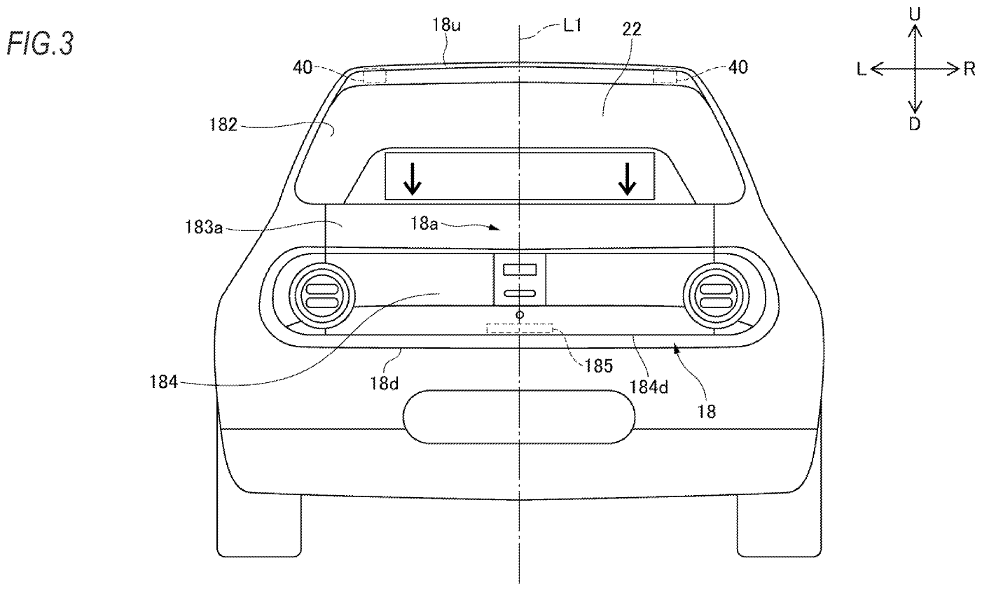

As illustrated in FIGS. 2 and 3, the vehicle V includes an opening portion 30 at the rear. The tailgate 18 is the outer shell member 1 which closes the opening portion 30 in a closed state. The vehicle V is provided with a tailgate hinge 40 which connects an upper edge portion 30u of the opening 30 and an upper end portion 18u of the tailgate 18. The tailgate hinges 40 are provided at two locations on the left and right, separated from each other in the left-right direction. Each of the pair of left and right tailgate hinges 40 has a pivot axis extending in the left-right direction. As illustrated by the arrow in FIG. 2, the tailgate 18 is pivotally supported by the vehicle V to pivot in the vertical direction around the pivot axis of the tailgate hinge 40 and open or close the opening portion.

A lock device 181 is provided at a lower end portion 18d of the tailgate 18. A striker 31 is provided at a lower edge portion 30d of the opening portion 30. When the tailgate 18 is in a closed state where the opening portion 30 is closed by the tailgate 18, the lock device 181 of the tailgate 18 is locked to the striker 31 and the tailgate 18 cannot be opened. When the lock device 181 is unlocked from the striker 31, the tailgate 18 can be opened.

In a rear view of the vehicle V, an upper region of the tailgate 18 is provided with an opening portion 182 extending in the up-down and left-right directions and penetrating in a front-rear direction and the opening portion 182 is closed by a tail window 22. The tail window 22 is formed of a light transmitting member which allows the outside of the vehicle to be visually recognized from inside the cabin CB, for example, smoked glass.

The tailgate 18 includes an outer panel 183 which forms an outer shell of a rear portion of the vehicle V and a garnish member 184 which is attached to an outer surface 183a which is a surface on the outer side of the vehicle V of the outer panel 183. In the embodiment, the garnish member 184 extends over the entire area in the left-right direction of the tailgate 18. The outer panel 183 is made of, for example, a steel plate. The garnish member 184 is made of, for example, resin. The garnish member 184 has lower rigidity than the outer panel 183. Here, low rigidity means that an amount of deflection is large with respect to an input load. Therefore, in the embodiment, when the same load is applied to each of the garnish member 184 and the outer panel 183, the amount of deflection of the garnish member 184 is larger than that of the outer panel 183.

The tail window 22, the outer panel 183 (excluding a portion where the garnish member 184 is disposed), and the garnish member 184 form an exterior surface 18a which is a surface on the outer side of the vehicle V of the tailgate 18.

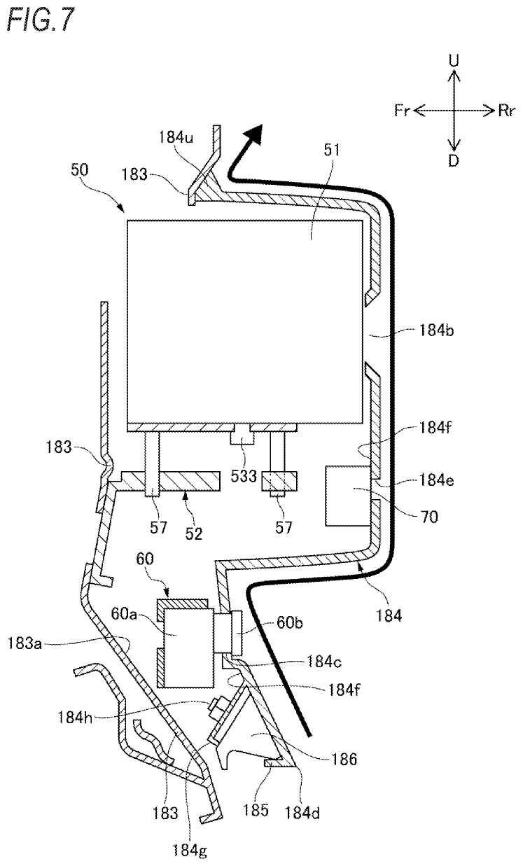

The garnish member 184 is provided with a handle portion 185 for a user to open the tailgate 18. The user grabs the handle portion 185 and pivots the tailgate 18 upward to open the tailgate 18. In the embodiment, the handle portion 185 is formed at a lower end portion 184d of the garnish member 184. The handle portion 185 and the outer surface 184a, which is the surface on the outer side of the vehicle V of the outer panel 183, are separated from each other in the front-rear direction and a space open downward is formed therebetween. The user can insert a finger between the outer surface 184a of the outer panel 183 and the handle portion 185 from below the handle portion 185 to grasp the handle portion 185 from below (see FIG. 7).

The handle portion 185 is provided at a position intersecting a center line L1 in the left-right direction of the vehicle V in the rear view of the vehicle V. In the embodiment, the handle portion 185 extends in the left-right direction to be substantially horizontally symmetrical with respect to the center line L1 in the left-right direction of the vehicle V in the rear surface view of the vehicle V. The handle portion 185 may extend in the left-right direction over the entire area in the left-right direction of the lower end portion 184d of the garnish member 184, or may extend in the left-right direction in a part of the lower end portion 184d of the garnish member 184 in the left-right direction.

(Opening Operation Device)

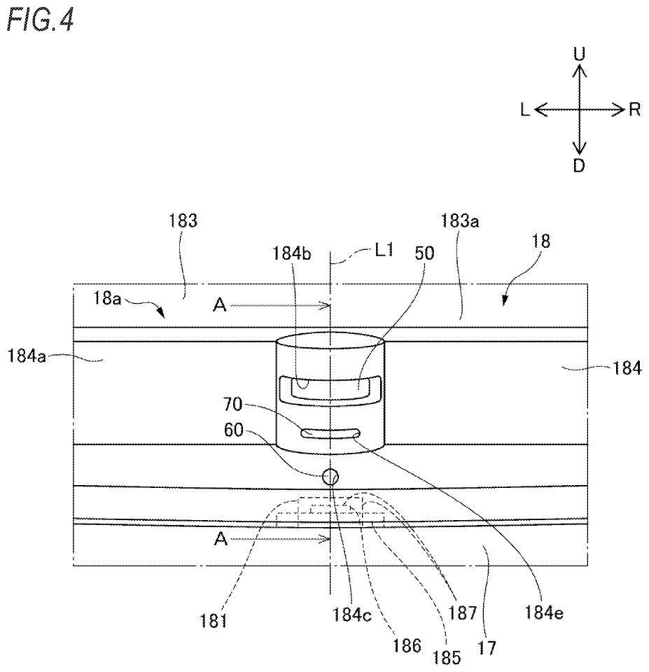

As illustrated in FIG. 4, the handle portion 185 is provided with an opening operation device 186 which is operated when a user opens the tailgate 18. When the opening operation device 186 is operated by the user, the lock device 181 releases the lock to the striker 31 and the tailgate 18 can be opened. Therefore, the user operates the opening operation device 186 provided in the handle portion 185 to release the lock between the lock device 181 and the striker 31, and then the user grasps the handle portion as it is and pivots the tailgate 18 upward to open the tailgate 18.

In the embodiment, the opening operation device 186 is a switch and the opening operation device 186 and the lock device 181 are electrically connected by a harness wire 187. When a user presses the switch as the opening operation device 186, the opening operation device 186 outputs an unlock signal to the lock device 181 via the harness wire 187 and the lock device 181 releases the lock to the striker 31 when the unlock signal is input. As the opening operation device 186, any switch such as a button type switch using an electric contact or a touch type switch using a capacitance sensor may be used.

(LiDAR Device)

The tailgate 18 is provided with a light detecting and ranging (LiDAR) device 50. By irradiating an object while scanning a pulsed laser beam and measuring scattered light rays and reflected light rays, a distance to the object at a long distance and the properties and shape of the object are analyzed, in such a manner that the LiDAR device 50 acquires a first external world information 500 of the vehicle V. The LiDAR device 50 is an example of a first external world information acquisition device and acquires the external world information behind the vehicle V as the first external world information 500.

The LiDAR device 50 is disposed between the outer panel 183 and the garnish member 184 and the rear side of the vehicle V is covered by the garnish member 184.

The garnish member 184 is provided with an opening portion 184b extending in the left-right direction at a position overlapping the LiDAR device 50 in the rear view of the vehicle V. Therefore, at least a part of the LiDAR device 50 is visible from behind the vehicle V through the opening portion 184b. The laser beam emitted from the LiDAR device 50 is emitted to the outside of the vehicle V through the opening portion 184b of the garnish member 184.

(Rear View Camera Device)

The tailgate 18 is provided with a rear view camera device 60. The rear view camera device 60 acquires a second external world information 600 of the vehicle V by forming an original image of the external world of the vehicle V on an image sensor element and converting it into a video signal which is an electric signal. The rear view camera device 60 is an example of a second external world information acquisition device and acquires the external world image behind the vehicle V as the second external world information 600.

In the embodiment, the LiDAR device 50 is disposed between the outer panel 183 and the garnish member 184 and the rear side of the vehicle V is covered by the garnish member 184.

The garnish member 184 is provided with a camera window portion 184c at a position overlapping the rear view camera device 60 in the rear view of the vehicle V. In the embodiment, the camera window portion 84c is an opening in which the rear view camera device 60 can be visually recognized from behind the vehicle V. The rear view camera device 60 acquires the external world image on the side of the vehicle V through the camera window portion 184c of the garnish member 184.

The rear view camera device 60 acquires the external world information in a vicinity of the vehicle V as the second external world information 600. The LiDAR device 50 can acquire the external world information in a region farther than an external world region in which the rear view camera device 60 can acquire the external world information. The LiDAR device 50 includes an area where the rear view camera device 60 can acquire the external world information and the LiDAR device 50 acquires external world information over a wider range far from the region where the rear view camera device 60 can acquire the external world information as the first external world information 500.

(Display Unit)

The tailgate 18 is provided with a display unit 70 which displays information based on an operating state of the LiDAR device 50 on the outside of the vehicle V. In the embodiment, the display unit 70 is an light emitting diode (LED) lighting device extending in the left-right direction.

The garnish member 184 is provided with a display window portion 184e which is an opening extending in the left-right direction between the opening portion 184b and the camera window portion 184c in the up-down direction in the rear view of the vehicle V. The display unit 70 is disposed at a position which can be visually recognized from the display window portion 184e in the rear view of the vehicle V and the display unit 70 displays information based on the operating state of the LiDAR device 50 to the outside of the vehicle V through the display window portion 184e of the garnish member 184.

(Fixing of LiDAR Device)

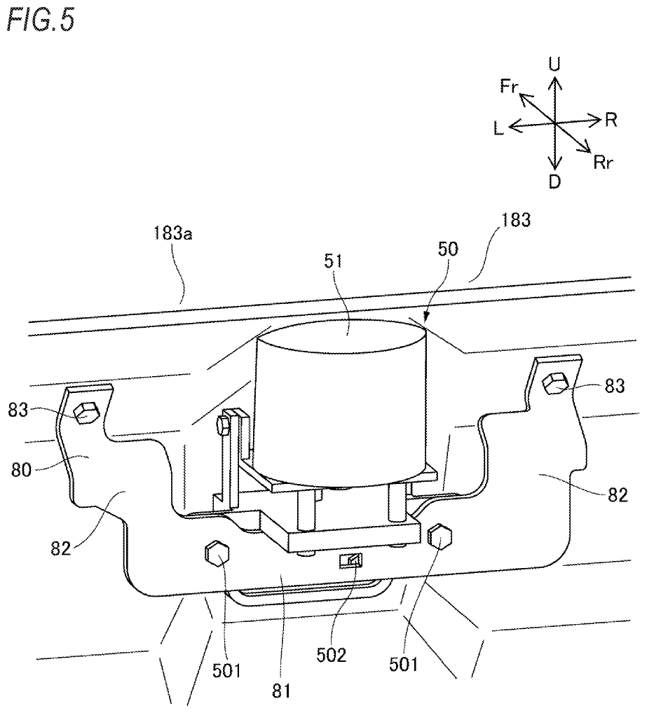

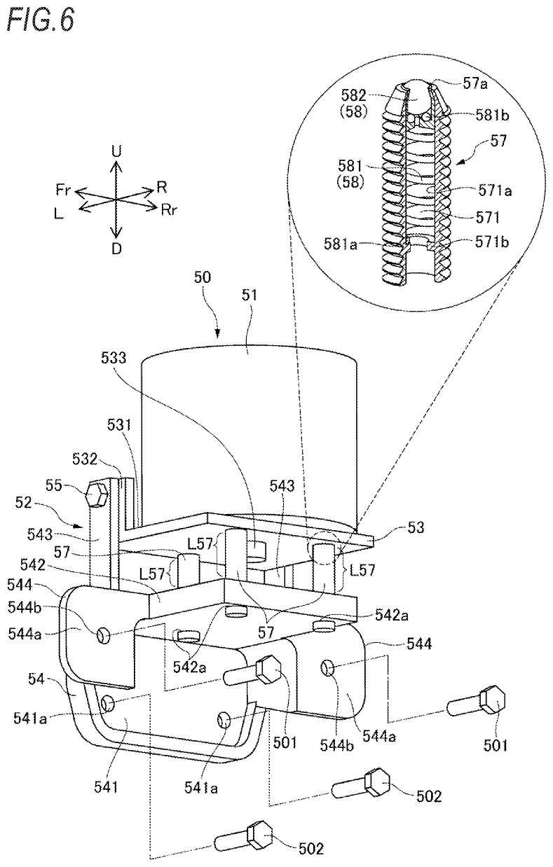

As illustrated in FIG. 5, the LiDAR device 50 is fixed to a bracket 80 fixed to the outer panel 183 by a fastening member 501 such as a bolt. The LiDAR device 50 is fixed to the outer surface 183a of the outer panel 183 by a fastening member 502 such as a bolt (see FIG. 6). As a result, in addition to being directly fixed to the outer panel 183, the LiDAR device 50 is also fixed to the outer panel 183 via the bracket 80, so that the LiDAR device 50 is more firmly fixed to the outer panel 183.

The bracket 80 has a flat plate shape extending in the up-down direction and the left-right direction. The bracket 80 includes an abutment portion 81 extending in the left-right direction across the LiDAR device 50 and a pair of left-right connection portions 82 extending upward from both left and right ends of the abutment portion 81. The bracket 80 is fixed to the outer panel 183 by a fastening member 83 inserted into a through hole formed in each of the pair of left and right connection portions 82.

As illustrated in FIG. 6, the LiDAR device 50 includes an external world information acquisition unit 51 which emits a pulsed laser beam while scanning and measures the scattered light rays and the reflected light rays and a fixing unit 52 on which the external world information acquisition unit 51 is placed and fixed and which is fixed to the outer panel 183 and the bracket 80.

The external world information acquisition unit 51 has a substantially cylindrical shape extending in the up-down direction. At least a part of a cylindrical surface of the external world information acquisition unit 51 is visible from behind the vehicle V through the opening portion 184b. The laser beam emitted from the external world information acquisition unit 51 is emitted to the outside of the vehicle V through the opening portion 184b of the garnish member 184.

The fixing unit 52 includes a pedestal member 53 on which the external world information acquisition unit 51 is placed and fixed and a connection member 54 which supports the pedestal member 53 in a displaceable manner and is fixed to the outer panel 183 and the bracket 80.

The pedestal member 53 includes a mounting portion 531 extending in the front-rear direction and the left-right direction and a pair of left and right protrusion portions 532 extending upward from both left and right ends of an end portion on an inner side of the vehicle V of the mounting portion 531. The external world information acquisition unit 51 is mounted on the mounting unit 531. The external world information acquisition unit 51 is mounted and fixed to the mounting portion 531 by a fastening member 533 inserted into a fixing hole formed in the mounting portion 531 that penetrates in the up-down direction.

The connection member 54 includes a fixing portion 541 extending in the up-down direction and the left-right direction below the pedestal member 53, a support portion 542 extending in the front-rear direction and the left-right direction from the upper end portion of the fixing portion 541 toward a rear outer side of the vehicle V, a pair of left and right protrusion portions 543 extending upward from both left and right ends of the upper end portion of the fixing portion 541, a pair of left and right bracket fixing portions 544 which are formed on a left side of a left end portion of the support portion 542 and a right side of a right end portion of the support portion 542 and have bracket fixing surfaces 544a extending in the up-down direction and the left-right direction further on a rear outer side of the vehicle V than the fixing portion 541. The pair of left and right bracket fixing portions 544 are all connected to the fixing portion 541 and the support portion 542.

In each of the bracket fixing surfaces 544a of the pair of left and right bracket fixing portions 544, an insertion hole 544b which penetrates in the front-rear direction and through which the fastening member 501 is inserted is formed.

The fixing portion 541 is formed with a pair of left and right insertion holes 541a which penetrate in the front-rear direction and through which the fastening members 502 are inserted.

The pair of left and right protrusion portions 532 of the pedestal member 53 are formed with insertion holes penetrating in the left-right direction and the pair of left and right protrusion portions 543 of the connection member 54 are formed with insertion holes penetrating in the left-right direction. Then, a fastening member 55 such as a bolt is inserted in the left-right direction through the insertion hole formed in the left protrusion portion 532 and the insertion hole formed in the left protrusion portion 543. Similarly, the fastening member 55 is inserted in the left-right direction through the insertion hole formed in the right protrusion portion 532 and the insertion hole formed in the right protrusion portion 543. As a result, the pedestal member 53 and the connection portion member 54 are connected by the fastening members 55 with the pair of left and right protrusion portions 532 of the pedestal member 53 and the pair of left and right protrusion portions 543 of the connection portion member 54. The pedestal member 53 is pivotally supported in the up-down direction with respect to the connection member 54 with the fastening members 55 inserted in the left-right direction as pivot axes.

A screw hole 542a penetrating in the up-down direction is formed in the support portion 542. In the embodiment, a total of three screw holes 542a are formed, two on the left and right sides in an outer region of the vehicle V in the support portion 542 and one at substantially the same position as the fastening member 55 in the front-rear direction of the vehicle V and at substantially the center in the left-right direction. A female screw groove is formed on an inner peripheral surface of each screw hole 542a and a position adjusting screw 57 is screwed from a lower side to an upper side and protrudes upward from the support portion 542. Each position adjusting screw 57 supports the mounting portion 531 of the pedestal member 53 from below. Then, by adjusting a protrusion length L57 protruding upward from the support portion 542 to adjust the position of the pedestal member 53, the two left and right position adjusting screws 57 disposed in the outer region of the vehicle V can adjust a fixed position of the external world information acquisition unit 51 fixed to the pedestal member 53. More specifically, when the protrusion length L57 protruding upward from the support portion 542 of the position adjusting screw 57 is shortened, the pedestal member 53 is supported by the connection member 54 so that the outside of the vehicle V faces downward with the fastening member 55 as the pivot axis and the external world information acquisition unit 51 is fixed to face downward toward the outside of the vehicle V. On the other hand, when the protrusion length L57 protruding upward from the support portion 542 of the position adjusting screw 57 is lengthened, the pedestal member 53 is supported by the connection member 54 so that the outside of the vehicle V faces upward with the fastening member 55 as the pivot axis and the external world information acquisition unit 51 is fixed to face upward toward the outside of the vehicle V.

The position adjusting screw 57 has a hollow portion 571 in which a tip portion 57a is open. On an inner peripheral surface 571a of the hollow portion 571, a protrusion portion 571b protruding toward an axial center side of the position adjusting screw 57 is formed at a position separated from the tip portion 57a by a predetermined distance.

A cushioning member 58 is provided in the hollow portion 571 of the position adjusting screw 57 so that a part thereof protrudes from the tip portion 57a. The cushioning member 58 includes a coil spring 581 which is an elastic member and a contact member 582 having a spherical shape. The coil spring 581 is disposed in the hollow portion 571 of the position adjusting screw 57 along an axial direction of the position adjusting screw 57. The coil spring 581 is disposed further on the tip portion 57a side than the protrusion portion 571b in the hollow portion 571 of the position adjusting screw 57. A first end portion 581a of the coil spring 581 abuts on the protrusion portion 571b of the hollow portion 571 of the position adjusting screw 57. The contact member 582 having a spherical shape abuts on a second end portion 581b of the coil spring 581. The coil spring 581 expands and contracts along the axial direction of the position adjusting screw 57 by an elastic force. The contact member 582 having a spherical shape is disposed to abut on the second end portion 581b of the coil spring 581 and a part thereof protrudes from the tip portion 57a of the position adjusting screw 57 and abuts on the mounting portion 531 of the pedestal member 53.

As such, the position adjusting screw 57 supports the external world information acquisition unit 51 via the cushioning member 58. Therefore, the external world information acquisition unit 51 is supported by the position adjusting screw 57 via the cushioning member 58. Then, the cushioning member 58 expands and contracts along the axial direction of the position adjusting screw 57 by the elastic force of the coil spring 581. Therefore, the cushioning member 58 can absorb an impact applied to the tailgate 18 when the tailgate 18 is pivoted in the up-down direction to open and close.

As a result, the impact applied to the tailgate 18 when the tailgate 18 is pivoted in the up-down direction to open and close is absorbed by the cushioning member 58 and prevented from being transmitted to the external world information acquisition unit 51. Therefore, it is possible to prevent changes in the mounting position and mounting angle of the external world information acquisition unit 51 due to the impact applied to the tailgate 18 when the tailgate 18 is pivoted in the up-down direction to open and close.

Since the cushioning member 58 is disposed in the hollow portion 571 of the position adjusting screw 57 so that a part thereof protrudes from the tip portion 57a of the position adjusting screw 57, the cushioning member 58 can be provided with excellent space efficiency.

The LiDAR device 50 is disposed so that the bracket fixing surfaces 544a of the pair of left and right bracket fixing portion 544 face the abutment portion 81 of the bracket 80 in the front-rear direction. The abutment portion 81 of the bracket 80 is formed with an insertion hole penetrating in the front-rear direction at a position overlapping the insertion hole 544b formed in the bracket fixing surface 544a when viewed from the front-rear direction. The LiDAR device 50 is fixed to the bracket 80 by the fastening member 501 which inserts the insertion hole 544b formed in the bracket fixing surface 544a and the insertion hole formed in the abutment portion 81 of the bracket 80.

The LiDAR device 50 is fixed to the outer panel 183 by the fastening member 502 which inserts an insertion hole 541a formed in the fixing portion 541 and an insertion hole (not illustrated) formed in the outer panel 183 that penetrates in the front-rear direction.

As illustrated in FIG. 7, the garnish member 184 is disposed to cover the rear side of the vehicle V of the LiDAR device 50. Therefore, the LiDAR device 50 is disposed below an upper end portion 184u of the garnish member 184 and is fixed to the outer panel 183 below the upper end portion 184u of the garnish member 184. The garnish member 184 is fixed to the outer panel 183 with the upper end portion 184u.

The LiDAR device 50 is disposed so that at least a part of a cylindrical surface of the external world information acquisition unit 51 can be visually recognized from the rear of the vehicle V through the opening portion 184b. The laser beam emitted from the external world information acquisition unit 51 is emitted to the outside of the vehicle V through the opening portion 184b of the garnish member 184.

(Fixing of Opening Operation Device)

The opening operation device 186 is provided between the handle portion 185 formed in the lower end portion 184d of the garnish member 184 and the outer surface 183a of the outer panel 183.

The opening operation device 186 is provided above a lower end of the handle portion 185 and is provided at a position which cannot be visually recognized by the rear view of the vehicle V. The opening operation device 186 is fixed to the garnish member 184 on an inner surface 184f, which is a surface on an inner side of the vehicle V of the garnish member 184. In the embodiment, a protrusion portion 184g which protrudes from the inner surface 184f of the garnish member 184 to the inside of the vehicle V is formed and the opening operation device 186 is fixed to the garnish member 184 by a fastening member 184h such as a bolt that inserts a through hole formed in the protrusion portion 184g.

When a user inserts a finger from below between the handle portion 185 and the outer surface 184a of the outer panel 183 and presses the opening operation device 186, which is a switch, upward and backward, the opening operation device 186 outputs an unlock signal to the lock device 181 via the harness wire 187 and the lock device 181 release the lock to the striker 31.

When the user presses the opening operation device 186, which is a switch, upward and backward, a load in an upward and backward direction is input to the opening operation device 186.

Here, the LiDAR device 50 is fixed to the outer panel 183, while the opening operation device 186 is fixed to the garnish member 184. Thus, the load in the upward and backward direction input to the opening operation device 186 by the operation of the opening operation device 186 by the user is transmitted to the garnish member 184, but is not directly transmitted from the garnish member 184 to the LiDAR device 50. Therefore, it is prevented that the load in the upward and backward direction input to the opening operation device 186 by the operation of the opening operation device 186 by the user is transmitted to the LiDAR device 50. As a result, it is possible to prevent the load input to the opening operation device 186 by the operation of the opening operation device 186 from being transmitted to the LiDAR device 50 and changing the mounting position and mounting angle of the LiDAR device 50.

Since the garnish member 184 to which the opening operation device 186 is fixed has lower rigidity than the outer panel 183, the load input to the opening operation device 186 by the operation of the opening operation device 186 by the user and transmitted to the garnish member 184 causes the garnish member 184 to be deformed to bend in the up-down direction. Then, by deforming the garnish member 184, the load transmitted to the garnish member 184 is absorbed, and thus the load input to the opening operation device 186 by the operation of the opening operation device 186 by the user is further prevented from being transmitted to the LiDAR device 50.

Since the garnish member 184 is fixed to the outer panel 183 with the upper end portion 184u, the load in the upward and backward direction input to the opening operation device 186 by the operation of the opening operation device 186 by the user is transmitted upward through the garnish member 184 and transmitted from the upper end portion 184u of the garnish member 184 to the outer panel 183, as indicated by the arrow in FIG. 7. Then, the load transmitted from the upper end portion 184u of the garnish member 184 to the outer panel 183 is transmitted upward through the outer panel 183. As such, the load in the upward and backward direction input to the opening operation device 186 by the operation of the opening operation device 186 by the user is transmitted through the garnish member 184 and the outer panel 183.

Since the LiDAR device 50 is fixed below the upper end portion 184u of the garnish member 184, the LiDAR device 50 is fixed to the outer panel 183 outside a transmission path of the load input to the opening operation device 186 by the operation of the opening operation device 186 by the user in the outer panel 183.

As a result, the load in the upward and backward direction input to the opening operation device 186 by the operation of the opening operation device 186 by the user is further prevented from being transmitted to the LiDAR device 50.

(Fixing of Rear View Camera Device)

The rear view camera device 60 is provided between the inner surface 184f of the garnish member 184 and the outer surface 183a of the outer panel 183 at a position above the handle portion 185 formed in the lower end portion 184d of the garnish member 184 and below the external world information acquisition unit 51 of the LiDAR device 50.

The rear view camera device 60 is fixed to the garnish member 184 on the inner surface 184f, which is the surface on the inner side of the vehicle V of the garnish member 184. In the embodiment, a main body unit 60a including the image sensor element and a conversion element and a lens unit 60b protruding from the main body unit 60a and capturing an original image of the external world of the vehicle V are provided.

In the embodiment, the rear view camera device 60 is fixed to the garnish member 184 by fitting the lens unit 60b into the camera window portion 184c, which is an opening provided in the garnish member 184. The rear view camera device 60 may be further fixed to the garnish member 184 by a fastening member such as a bolt.

The rear view camera device 60 captures the original image of the external world of the vehicle V through the lens unit 60b fitted to the camera window portion 184c of the garnish member 184 and forms an image on the image sensor element of the main body unit 60a, and then the rear view camera device 60 converts the image into a video signal which is an electric signal by the conversion element of the main body unit 60a.

(Fixing of Display Unit)

The display unit 70 is provided between the inner surface 184f of the garnish member 184 and the outer surface 184a of the outer panel 183 at a position above the rear view camera device 60 and below the external world information acquisition unit 51 of the LiDAR device 50.

The display unit 70 is fixed to the garnish member 184 on the inner surface 184f, which is the surface on the inner side of the vehicle V of the garnish member 184.

In the embodiment, the display unit 70 abuts on the inner surface 184f of the garnish member 184 to overlap the display window portion 184e, which is an opening provided in the garnish member 184, in the rear view and is fixed to the garnish member 184 by a fastening member (not illustrated) such as a bolt.

The display unit 70 displays information based on the operating state of the LiDAR device 50 to the outside of the vehicle V through the display window portion 84e of the garnish member 184.

(Vehicle Driving Control Device)

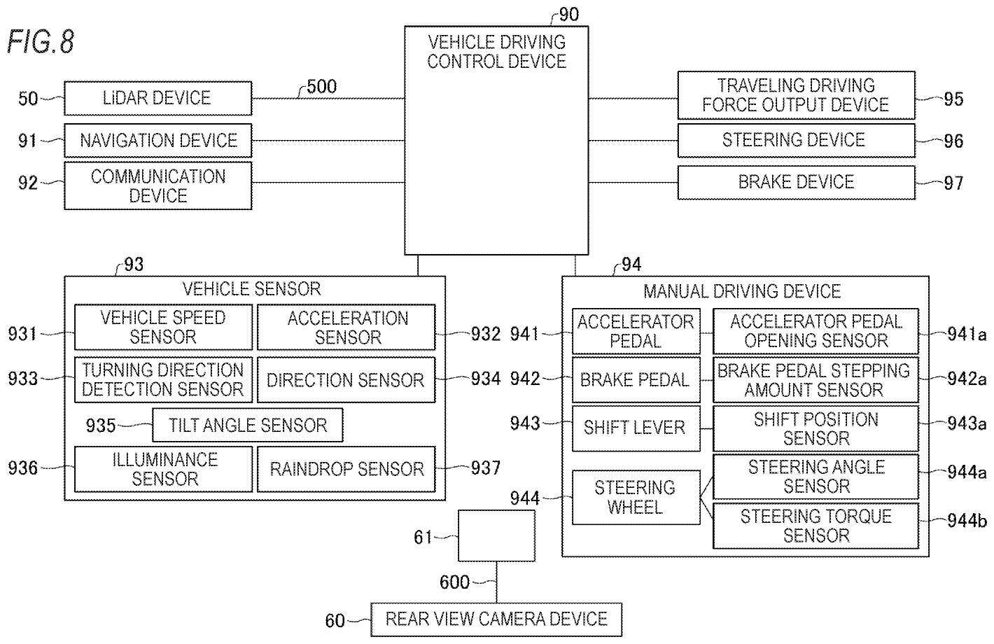

Next, a vehicle driving control device 90 mounted on the vehicle V will be described with reference to FIG. 8.

In addition to the above-described LiDAR device 50 and rear view camera device 60, the vehicle V is equipped with a navigation device 91, a communication device 92, a vehicle sensor 93, a manual driving device 94, and a traveling driving force output device 95, a steering device 96, and a brake device 97.

The vehicle driving control device 90 is connected to the LiDAR device 50, the navigation device 91, the communication device 92, the vehicle sensor 93, the manual driving device 94, the traveling driving force output device 95, the steering device 96, and the brake device 97 to be capable of data communication with each other via a communication medium.

The navigation device 91 includes a global navigation satellite system (GNSS) receiver, map information, and the like. The navigation device 91 has a function of detecting a current position of the vehicle V by the GNSS receiver and deriving a route to a destination specified by an occupant of the vehicle V or the like based on the detected current position and the map information.

The communication device 92 wirelessly communicates with an information providing server of a system which monitors a traffic condition of a road and acquires traffic information indicating a traffic condition of the road on which the vehicle V is traveling or the road to be traveled. The traffic information includes information such as traffic jam information ahead, information on time required to pass a traffic jam point, accident, breakdown vehicle, and construction information, speed regulation and lane regulation information, parking lot location information, and information on full or empty of a parking lot, a service area, and a parking area. The communication device 92 may acquire the traffic information by road-to-vehicle communication with a wireless beacon provided on a side zone of a road or by vehicle-to-vehicle communication with another vehicle traveling around the vehicle V.

The communication device 92 wirelessly communicates with an information providing server of a signal information utilization driving support system (traffic signal prediction systems (TSPS)) and acquires signal information of a traffic light provided on the road on which the vehicle V is traveling or is scheduled to travel. The TSPS uses the signal information of a traffic light to support driving to smoothly pass through a signalized intersection. The communication device 92 may acquire signal information by road-to-vehicle communication with a wireless beacon provided in a side zone of a road or the like, or by vehicle-to-vehicle communication with another vehicle traveling around the vehicle V.

The vehicle sensor 93 has a function of detecting various information about the vehicle V The vehicle sensor 93 includes various sensors for detecting a moving state of the vehicle V, including a vehicle speed sensor 931 for detecting a vehicle speed of the vehicle V, an acceleration sensor 932 which detects acceleration in the front-rear direction and left-right direction of the vehicle V, a turning direction detection sensor 933 which detects a turning direction of the vehicle V from an angular velocity around a vertical axis of the vehicle V, a direction sensor 934 which detects an orientation of the vehicle V, and a tilt angle sensor 935 which detects a tilt angle of the vehicle V. The vehicle sensor 93 further includes various sensors for detecting an external environment of the vehicle V, including an illuminance sensor 936 for detecting an illuminance at a location of the vehicle V and a raindrop sensor 937 for detecting an amount of raindrops at the location of the vehicle V.

The manual driving device 94 includes an accelerator pedal 941, which is an acceleration and deceleration operation member which receives acceleration and deceleration instructions from an occupant, a brake pedal 942, which is a braking operation member which receives braking instructions from the occupant, a shift lever 943, which is a shift operation member for receiving a shift change instruction by the occupant, and a steering wheel 944, which is a steering member which receives turning instructions from the occupant.

The manual driving device 94 further includes an accelerator pedal opening sensor 941a, which detects an amount of depression of the accelerator pedal 941 and outputs an accelerator opening signal to the vehicle driving control device 90, a brake pedal stepping amount sensor 942a, which detects a stepping amount (or stepping force) of the brake pedal 942 and outputs a brake signal to the vehicle driving control device 90, a shift position sensor 943a, which detects a shift stage indicated by the shift lever 943 and outputs a shift position signal to the vehicle driving control device 90, a steering steering-angle sensor 944a, which detects a steering angle of the steering wheel 944 and outputs a steering steering-angle signal to the vehicle driving control device 90, and a steering torque sensor 944b, which detects the torque applied to the steering wheel 944 and outputs a steering torque signal to the vehicle driving control device 90.

The traveling driving force output device 95 is a device which includes a drive source and outputs the power of the drive source as a driving force of the vehicle V to the front wheels FW and/or the rear wheels RW which are driving wheels.

The steering device 96 is a device for changing the direction of the front wheels FW and/or the rear wheels RW, which are steered wheels of the vehicle V.

The brake device 97 is a device which outputs braking force to the front wheel FW and the rear wheel RW.

The vehicle driving control device 90 is composed of, for example, one or more processors or hardware having equivalent functions. The vehicle driving control device 90 may have a configuration in which a processor such as a central processing unit (CPU), a storage device, an electronic control unit (ECU) or a micro-processing unit (MPU) to which a communication interface is connected by an internal bus, and the like are combined.

The vehicle driving control device 90 controls the driving (movement) of the vehicle V by controlling the traveling driving force output device 95, the steering device 96, and the brake device 97. The vehicle driving control device 90 controls the traveling driving force output device 95, the steering device 96, and the brake device 97 by executing a program (software) by the processor. A part or all of these control functions may be realized by hardware such as a large scale integration (LSI) or an application specific integrated circuit (ASIC), or may be realized by a combination of software and hardware.

The vehicle driving control device 90 can control the traveling driving force output device 95, the steering device 96, and the brake device 97 based on the operation of the manual driving device 94 by an occupant and can manually drive the vehicle V.

When manually driving the vehicle V, the vehicle driving control device 90 may control the traveling driving force output device 95, the steering device 96, and the brake device 97 based on one or more pieces of information among the first external world information 500 acquired by the LiDAR device 50, the current position of the vehicle V detected by the navigation device 91, the map information of the navigation device 91, the route to the destination of the vehicle V derived by the navigation device 91, the traffic information and signal information acquired by the communication device 92, the moving state of the vehicle V and the external environment of the vehicle V which are acquired by the vehicle sensor 93, in addition to the accelerator opening signal, the brake signal, the shift position signal, the steering steering-angle signal, the steering torque signal, and the like output from the manual driving device 94.

The vehicle driving control device 90 can control the traveling driving force output device 95, the steering device 96, and the brake device 97 without the operation of the manual driving device 94 by an occupant and can autonomously drive (autonomous movement) the vehicle V.

When the vehicle V is autonomously driven, the vehicle driving control device 90 controls the traveling driving force output device 95, the steering device 96, and the brake device 97 based on the first external world information 500 acquired by the LiDAR device 50, the current position of the vehicle V detected by the navigation device 91, the map information of the navigation device 91, the route to the destination of the vehicle V derived by the navigation device 91, the traffic information and signal information acquired by the communication device 92, and the moving state of the vehicle V and the external environment of the vehicle V which are acquired by the vehicle sensor 93 and causes the vehicle V to be autonomously driven (autonomous movement).

In the embodiment, the rear view camera device 60 is not directly connected to the vehicle driving control device 90 so that data communication is possible. Then, the vehicle driving control device 90 controls the traveling driving force output device 95, the steering device 96, and the brake device 97 regardless of the second external world information 600 acquired by the rear view camera device 60. Therefore, the vehicle V autonomously operates regardless of the second external world information 600 acquired by the rear view camera device 60.

The second external world information 600 acquired by the rear view camera device 60 is displayed as an external world image behind the vehicle V on a display device 61 composed of a liquid crystal display (LCD) panel, an organic electroluminescence (EL) display panel, or the like provided in the cabin CB.

### Modification Example

In the embodiment described above, the cushioning member 58 includes the coil spring 581 and the contact member 582 and is provided in the hollow portion 571 of the position adjusting screw 57 so that a part of the cushioning member 58 protrudes from the tip portion 57a. However, the cushioning member 58 may not be provided on the position adjusting screw 57.

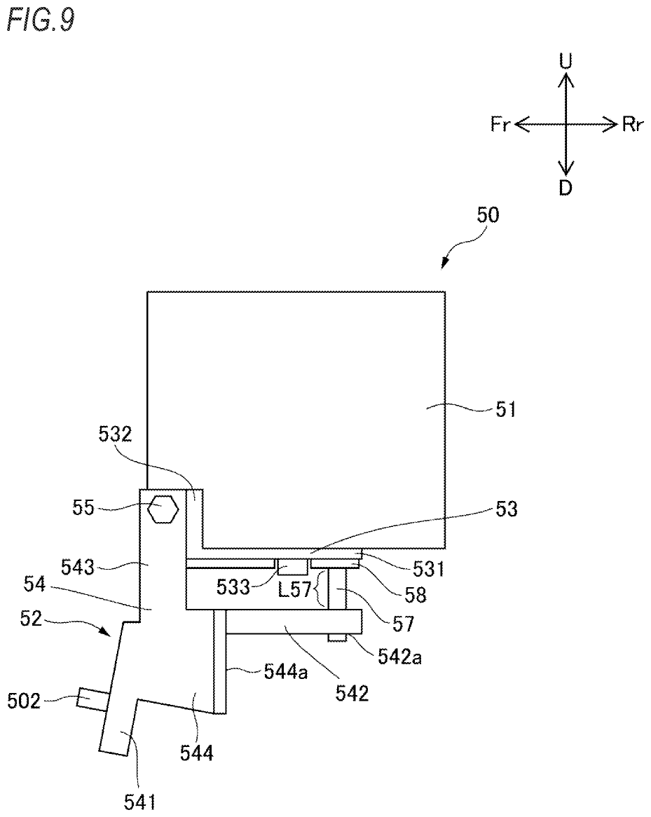

As illustrated in FIG. 9, in the modification example, the cushioning member 58 is an elastic sheet provided on a lower surface of the mounting portion 531 of the pedestal member 53. Then, the tip portion 57a of the position adjusting screw 57 abuts on the cushioning member 58, which is an elastic sheet provided on the lower surface of the mounting portion 531 of the pedal member 53, and supports the mounting portion 531 of the pedestal member 53 from below. As such, the position adjusting screw 57 supports the external world information acquisition unit 51 via the cushioning member 58. Then, the cushioning member 58 can absorb the impact applied to the tailgate 18 when the tailgate 18 pivots in the up-down direction to open and close by the elastic force of the elastic sheet.

As a result, the impact applied to the tailgate 18 when the tailgate 18 pivots in the up-down direction to open and close is prevented from being transmitted to the external world information acquisition unit 51. Therefore, it is possible to prevent changes in the mounting position and mounting angle of the external world information acquisition unit 51 due to the impact applied to the tailgate 18 when the tailgate 18 pivots in the up-down direction to open and close.

In the modification example, the cushioning member 58 is a single elastic sheet provided on the lower surface of the mounting portion 531 of the pedestal member 53 and one elastic sheet, the cushioning member 58, abuts on the tip portions 57a of three position adjusting screws 57, two position adjusting screws 57 placed on the left and right sides of the outer region of the vehicle V in the support portion 542 and one position adjusting screw 57 placed at approximately the same position as the fastening member 55 in the front-rear direction of the vehicle V and approximately in the center in the left-right direction. However, a cushioning member 58, which is an elastic sheet, may be separately provided at a position where the tip portion 57a of each position adjusting screw 57 abuts.

Although one embodiment of the invention is described above with reference to the accompanying drawings, it goes without saving that the invention is not limited to such an embodiment. It is clear that a person skilled in the art can come up with various change examples or modification examples within the scope of the claims and it is naturally understood that the change and modification examples also belong to the technical scope of the invention. Each component in the above embodiment may be arbitrarily combined as long as the gist of the invention is not deviated.

For example, in the embodiment, a vehicle is described as an example of the moving body of the invention, but the moving body is not limited to a vehicle. The moving body is not limited to a vehicle and may be a robot, a ship, an aircraft, or the like which includes a drive source and can move by the power of the drive source.

For example, in the embodiment, the tailgate 18 is described as an example of the opening and closing body of the moving body, but the opening and closing body of the moving body may be, for example, the front door 10F or the rear door 10R of the vehicle V. For example, the front door 10F is connected to the vehicle V by a hinge having a pivot axis whose front end portion extends in the up-down direction and the front door 10F may be pivotally supported by the vehicle V to pivot in the front-rear direction around the pivot axis extending in the up-down direction to open and close. The rear door 10R may be a sliding door which slides in the front-rear direction and is attached to the vehicle V to be openable and closable.

For example, in the embodiment, as an example of the opening and closing body of the moving body, the tailgate 18 provided on the rear surface of the vehicle V is described, but the opening and closing body of the moving body may be provided on the front surface of the moving body.

For example, in the embodiment, the external world information acquisition device is assumed to be the LiDAR device 50. However, the LiDAR device 50 is an example of the external world information acquisition device and the external world information acquisition device is not limited to the LiDAR device 50. The external world information acquisition device may be a device capable of acquiring the external world information of the vehicle V by means other than the LiDAR and may be, for example, a millimeter wave radar device or a camera device.

For example, in the embodiment, the opening operation device 186 is a switch and it is assumed that the opening operation device 186 and the lock device 181 are electrically connected by the harness wire 187. However, the opening operation device 186 may be a lever device or a handle device provided integrally with the handle portion 185 and the opening operation device 186 and the lock device 181 may be connected by an operation force transmission member composed of a Bowden cable or the like. Here, when a user operates the opening operation device 186, the operation force is transmitted to the lock device 181 via the operation force transmission member and the lock device 181 releases the lock to the striker 31 by the operation force transmitted from the opening operation device 186 via the operation force transmission member.

At least the following matters are described in the specification. In parentheses, the corresponding components and the like in the embodiment described above are shown as an example, but the invention is not limited thereto.

(1) A moving body (vehicle V) including

an opening and closing body (tailgate 18), attached to be openable and closable, including:

an opening operation device (opening operation device 186) operated by a user when opening the opening and closing body; and

an external world information acquisition device (LiDAR device 50) including an external world information acquisition unit (external world information acquisition unit 51) which acquires external world information of the moving body;

a panel member (outer panel 183) forming an outer shell of the moving body; and

a garnish member (garnish member 184) attached to an outer surface (outer surface 183a) of the panel member, which is a surface on an outer side of the moving body, where:

the external world information acquisition device is fixed to the panel member; and

the opening operation device is fixed to the garnish member.

According to (1), the external world information acquisition device is fixed to the panel member, while the opening operation device is fixed to the garnish member. Thus, the load input to the opening operation device by the operation of the opening operation device by the user is prevented from being transmitted to the external world information acquisition device. As a result, it is possible to prevent the load input to the opening operation device by the operation of the opening operation device of the opening and closing body by the user from being transmitted to the external world information acquisition device attached to the opening and closing body and changing the mounting position and mounting angle of the external world information acquisition device.

(2) The moving body according to (1), where

the garnish member has lower rigidity than the panel member.

According to (2), since the garnish member to which the opening operation device is fixed has the lower rigidity than the panel member, the load input to the opening operation device by the operation of the opening operation device by the user and transmitted to the garnish member causes the garnish member to be deformed. Then, by deforming the garnish member, the load transmitted to the garnish member is absorbed, and thus the load input to the opening operation device by the operation of the opening operation device by the user is further prevented from being transmitted to the external world information acquisition device.

(3) The moving body according to (1) or (2), where:

a load input to the opening operation device by an operation of the opening operation device by the user is transmitted through the garnish member and the panel member; and

the external world information acquisition device is fixed to the panel member outside a transmission path of the load in the panel member.

According to (3), the external world information acquisition device is fixed to the panel member outside the transmission path of the load input to the opening operation device by the operation of the opening operation device by the user in the panel member. As a result, the load input to the opening operation device by the operation of the opening operation device by the user is further prevented from being transmitted to the external world information acquisition device.

(4) The moving body according to any one of (1) to (3), further including

a position adjusting member (position adjusting screw 57) configured to adjust a fixed position of the external world information acquisition unit is further provided, where the position adjusting member supports the external world information acquisition unit via a cushioning member (cushioning member 58).

According to (4), the external world information acquisition unit is supported by the position adjusting member via the cushioning member. Therefore, the impact applied to the opening and closing body w % ben the opening and closing body is opened and closed is absorbed by the cushioning member and prevented from being transmitted to the external world information acquisition unit. As a result, it is possible to prevent changes in the mounting position and mounting angle of the external world information acquisition unit due to the impact applied to the opening and closing body when the opening and closing body is opened and closed.

(5) The moving body according to (4), w % here:

the position adjusting member is a screw member (position adjusting screw 57) having a hollow portion (hollow portion 571) with a tip portion (tip portion 57a) opened; and

the cushioning member is provided in the hollow portion of the screw member so that a part of the cushioning member protrudes from the tip portion of the screw member.

According to (5), since the cushioning member is disposed in the hollow portion of the screw member so that a part thereof protrudes from the tip portion of the screw member, the cushioning member can be provided with excellent space efficiency.

1. A moving body comprising:
an opening and closing body, attached to be openable and closable, including:
an opening operation device operated by a user when opening the opening and closing body;
an external world information acquisition device including an external world information acquisition unit which acquires external world information of the moving body;
a panel member forming an outer shell of the moving body; and
a garnish member attached to an outer surface of the panel member, which is a surface on an outer side of the moving body, wherein:
the external world information acquisition device is fixed to the panel member; and
the opening operation device is fixed to the garnish member.

2. The moving body according to claim 1, wherein
the garnish member has lower rigidity than the panel member.

3. The moving body according to claim 1, wherein:
a load input to the opening operation device by an operation of the opening operation device by the user is transmitted through the garnish member and the panel member; and
the external world information acquisition device is fixed to the panel member outside a transmission path of the load in the panel member.

4. The moving body according to claim 1, further comprising
a position adjusting member configured to adjust a fixed position of the external world information acquisition unit is further provided, wherein
the position adjusting member supports the external world information acquisition unit via a cushioning member.

5. The moving body according to claim 4, wherein:
the position adjusting member is a screw member having a hollow portion with a tip portion opened; and
the cushioning member is provided in the hollow portion of the screw member so that a part of the cushioning member protrudes from the tip portion of the screw member.
